(19) United States
(12) Patent Application Publication
(10) Pub. No.: US 2014/0110520 A1
(43) Pub. Date: Apr. 24, 2014

(54) Trailer Tie-Down Strap Retrieval Spool

(71) Applicant: Bruce Hampson, Parksville (CA)

(72) Inventor: Bruce Hampson, Parksville (CA)

(21) Appl. No.: 13/957,512

(22) Filed: Aug. 2, 2013

Related U.S. Application Data
(60) Provisional application No. 61/715,871, filed on Oct. 19, 2012.

(51) Int. Cl. B60P 7/08

(52) U.S. Cl. CPC B60P 7/0846
USPC 242/395

(57) ABSTRACT

A cargo strap retrieval device is provided having a rotatable spool supported by a frame structure that is adapted to be secured within the side rail of a cargo trailer. The frame comprises a first upstanding member for supporting the rotatable spool, a perpendicular shelf member extending from the upstanding member lower edge and below the spool, and a step-down side rail connector member at the end of the shelf member that secures within the open cavity of a trailer side rail to support the entire assembly while in use. The spool comprises a pair of tongs along the first side of the upstanding member for supporting a cargo strap as it winds therearound, while a backside drive member provides a user with a means of input for the spool, whereby a hand crank, ratchet, or electric drill may be utilized to drive the spool as it collects the cargo strap therearound.

### CROSS REFERENCE TO RELATED APPLICATION

This application claims the benefit of U.S. Provisional Application No. 61/715,871 filed on Oct. 19, 2012, entitled “Strap Mate.” The above identified patent application is herein incorporated by reference in its entirety to provide continuity of disclosure.

### BACKGROUND OF THE INVENTION

1. Field of the Invention

The present invention relates to tie down straps and spool devices. More specifically, the present invention pertains to a new and novel tied down strap spool that can be wound to retrieve a length of tie down strap for a trailer without resorting to winding the strap by hand.

Cargo and tie down straps are well known articles that are widely used in the shipping, transport, and hauling industry. These include elongated material straps with a high tensile strength that are placed over cargo being hauled in a trailer, flatbed, or pickup truck. The straps act as a webbing that is tensioned over the hauled cargo to limit relative movement between the cargo and the carrying vehicle, whereby the condition of the cargo is maintained over long distances and during periods of rapid momentum shifts or rough terrain.

For open air trailers and highboy trailers, these straps are secured to the trailer and lashed over the cargo to secure the cargo to the trailer surface. These trailers generally have an open configuration that allows for bulky cargo to be secured to a flat surface to be hauled over a distance. The trailers generally have tie down locations or a first and second side rail that allows for the straps to be secured and tensioned therefrom. The side rails are elongated structural members having an open cell configuration, wherein hooks and other mechanical assemblies can be attached therealong without the assembly sliding the entire length of the rail. When deploying cargo straps, the strap ends are secured to the opposing side rails and tensioned over the cargo to limit its movement and press the cargo against trailer surface.

Deploying cargo straps is a largely efficient process, whereby the strap is positioned over the cargo, secured to the opposing side rails, and then tensioned therebetween by way of a winch that shortens the length of strap between the rails and over the cargo. However, the act of retrieving and stowing the long cargo straps is a chore and a time consuming task. Most truckers and hauler will coil the straps about themselves to form wound spools thereof. Others will simply place the unwound cargo straps into a bin or container for later retrieval. The former option is not efficient and the latter is prone to causing time delays when re-deploying and untangling the disorganized the straps.

The present invention provides a means of coiling a length of tie down strap or cargo strap without requiring the user to wind the strap by hand or neglect to collect it altogether. The device provides a rotatable spool that is supported by an upstanding structure, wherein the structure includes a lower portion that adapted to be supported with the side rails of a trailer without further assistance by the user or a permanent attachment means. The spool can be driven by an electric drill that rotates the spool armature, or alternately a removable hand crank can be positioned onto the spool receiver to drive the spool armature collecting and coiling the strap length. The device is adapted to be deployed for a short time and then stowed, whereby the cargo straps can all be coiled and efficiently collected after a cargo has reached its destination.

2. Description of the Prior Art

Devices have been disclosed in the prior art that relate to winding devices and cargo strap coiling means. These include devices that have been patented and published in patent application publications, and generally relate to tie down and cargo strap retrieval devices having varying elements and connection means with respect to a trailer or alternate support location. The present invention provides a drivable spool device supported from a unique body structure that allow removable connection with a trailer side rail while in use. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 8,192,119 to Small, which describes a trailer cargo strap collection device having a hollow base, an upstanding post member, and a winder assembly for winding a length of tie down strap around a cylindrical sleeve. The hollow base is adapted to fit into a trailer stake pocket, while the upstanding post member comprises a first and second telescoping member securable in position by a locking pin. The winder assembly comprises a rotating sleeve member within a channel, which is driven by a hand crank or driven by an electric drill. The Small device, while providing a winding assembly for cargo straps, diverges in structural elements with respect to its connection with the trailer side rails.

Another such device is U.S. Pat. No. 6,626,621 to Hugg, which describes a trailer cargo strap winch device that comprises a generally Y-shaped body having a lower portion that fits within the elongated side rails of a flatbed truck. Between the opposing vertical portions of the Y-shaped body is a winch assembly that allows a tie down strap to be ratcheted onto a coil for tie down and for strap collection purposes. When the device is placed within the flatbed side rails, a hook member latches the device securely into position. The Hugg device provides a unique and useful means of ratcheting down a cargo strap over hauled cargo, however its structure and purpose diverges from that of the present invention.

U.S. Patent Publication No. 2006/0022104 to Treat also discloses an apparatus for winding a cargo strap, comprising a bracket having a pair of legs extending downwardly from a bracket top, whereby the bracket top is fitted within an elongated rail of a flatbed truck or trailer. The bracket legs include a pair of aligned notches through which a hand crank is positioned. The hand crank supports the end of a cargo strap and is used to wind the length of strap therearound and between the bracket legs. Similar to the Hugg and Small devices, the Treat device fails to disclose the structure and side rail connection of the present invention.

Finally, U.S. Pat. No. 6,179,534 to Weckter discloses a strap roller device for winding cargo straps into a roll using a hand crank. The device comprises a mounting bracket connected to a tubular bore member that rotatably supports an elongated member therethrough. The elongated member has a first hand crank end and a second strap take-up end with a slot therethrough for grasping the strap before winding operations. The user rotates the hand crank handle to wind the elongated strap about the elongated member strap take-up end. The Weckter device requires permanent connection to its support structure. The present invention is provided such that it can be rapidly deployed, supported by the trailer, and thereafter removed without the use of fasteners or other connector elements.

The present invention provides a cargo strap or tie down strap collection device that allows a rotatable spool to be supported above a trailer by way of a structure that fits within the trailer side rails while in use. The body structure of the device allows for rapid and firm connection to a trailer side rail and subsequent removal thereof after all cargo winding activities have ceased. It is submitted that the present invention substantially diverges in design elements from the prior art, and consequently it is clear that there is a need in the art for an improvement to existing cargo strap collection devices. In this regard the instant invention substantially fulfills these needs.

### SUMMARY OF THE INVENTION

In view of the foregoing disadvantages inherent in the known types of cargo strap collection devices now present in the prior art, the present invention provides a new, trailer mounted cargo collection device that can be utilized for providing convenience for the user when retrieving an elongated length of cargo strap without resorting to winding the length or organizing the length by hand.

It is therefore an object of the present invention to provide a new and improved cargo strap collection device that has all of the advantages of the prior art and none of the disadvantages.

It is another object of the present invention to provide a cargo strap collection device that can be rapidly connected to and thereafter removed from a cargo trailer side rail, whereby the body structure of the present device is adapted to conform to the side rail pocket structure and be supported by simple insertion thereinto, whereafter the cargo spool is freely supported without user assistance.

Another object of the present invention is to provide a cargo strap collection device having an upstanding body structure to support a freely rotatable spool therefrom and above the surface of a trailer.

Yet another object of the present invention is to provide a cargo strap collection device that includes a rotatable spool that can be driven by way of a hand crank, a ratchet tool, or a power tool such as an electric drill, whereby a length of cargo strap is rapidly and efficiently would around the tongs of the spool.

A final object of the present invention is to provide a cargo strap collection device having a two-pronged spool such that a cargo strap can be placed between the tongs to initiate the spooling action, eliminating the possibility of slippage between the rotating spool and the cargo strap.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an exemplary embodiment of the present invention.

FIG. 2 shows a frontal view of the exemplary embodiment of the present invention.

FIG. 3 shows an overhead perspective view of the present invention in a working state, collecting a length of cargo strap and being driven by a drill tool.

### DETAILED DESCRIPTION OF THE INVENTION

Reference is made herein to the attached drawings. Like reference numerals are used throughout the drawings to depict like or similar elements of the cargo strap collection device. For the purposes of presenting a brief and clear description of the present invention, the preferred embodiment will be discussed as used for providing a tool for rapidly and efficiently winding an elongated cargo strap from a trailer having side rails. The figures are intended for representative purposes only and should not be considered to be limiting in any respect.

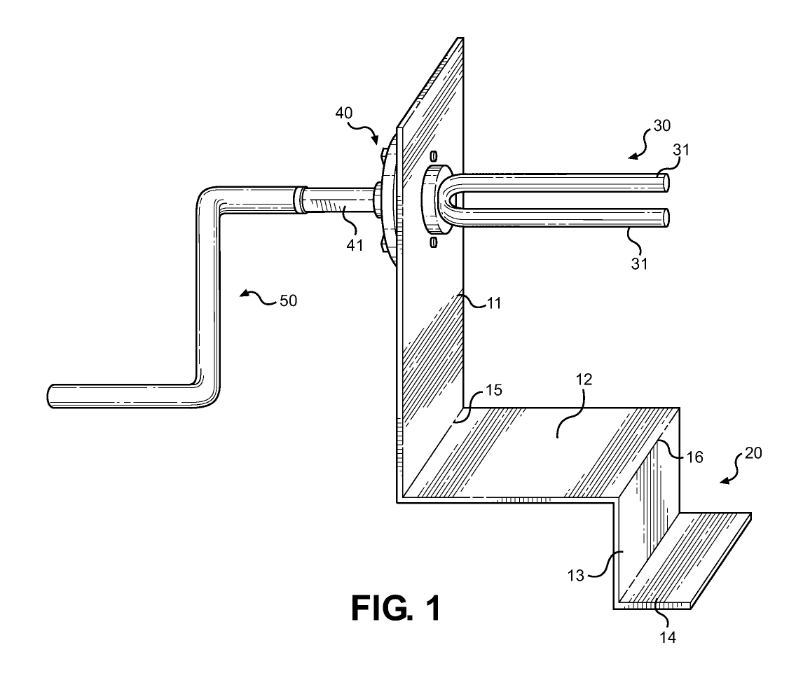

Referring now to FIG. 1, there is shown a perspective view of the cargo strap collection device of the present invention. The device provides an upstanding spool 30 that is attachable to a frame that couples to the open pocket of a truck side rail, whereby the frame is supported as a user manipulates the spool 30 to draw in a length of cargo strap or tie down thereonto. The frame comprises an upstanding member 11 having an upper edge and a lower edge 15. Along the lower edge 15 is a perpendicular shelf member 12 that extends therefrom to form a shelf below the spool 30 and to create an L-shaped frame. The distal edge 16 of the shelf member 12 further connects to a trailer side rail connector 20, which is adapted to rest within the pocket or side rail of a trailer and support the L-shaped frame in an upright configuration. The connector 20 comprises a vertical member 13 and a horizontal member 14, wherein the horizontal member 14 spans across the pocket interior and bears against the wall thereof to prevent tipping of the L-shaped frame upper.

The spool 30 is a rotatable member that extends through the L-shaped frame upstanding member 11 for drawing in an elongated cargo strap. A bearing assembly 40 supports the spool 30 in a rotatable fashion, whereby the spool 30 can be rotated in either direction by way of a drive member 41 along the backside of the upstanding member 11. The drive member 41 provides a connection point for a hand crank 50, electric, or pneumatic drive means for winding the spool 30 during the strap collection.

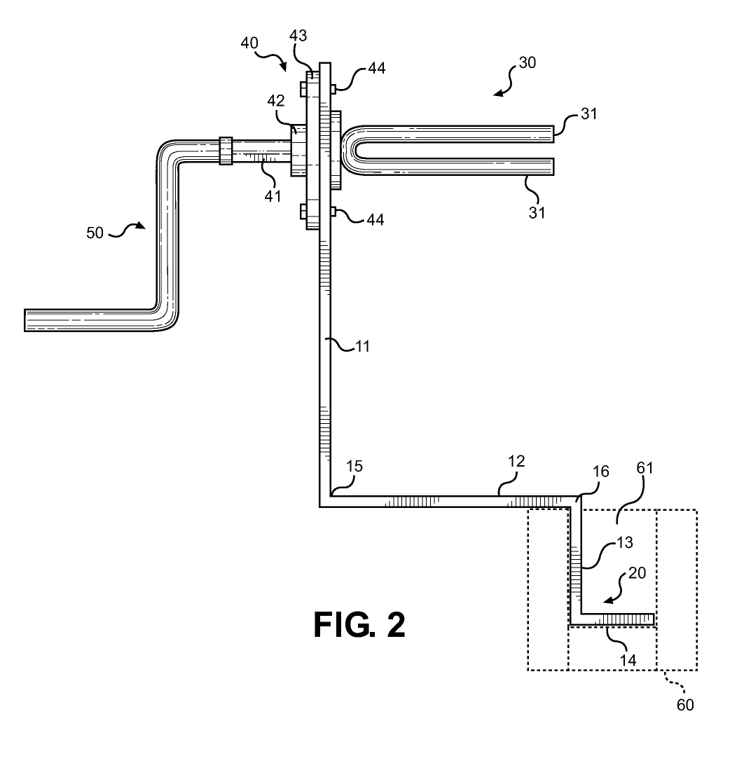

Referring now to FIGS. 1 and 2, both a side and perspective view of the device is shown. The spool member 30 comprises a first and second tong 30 separated by a gap therebetween. The gap is used to feed a length of strap therethrough to start the strap collection process. As the spool is spun, the tongs 31 draw the strap around its structure and wind the strap therearound into a coiled configuration for improved storage. Tongs 31 connect directly to the rearmost drive member 41 such that rotation of the drive member 41 results in a direct drive of the tongs 31.

The drive member 41 is rotatably supported by the bearing assembly, which comprises a bearing housing 42 supported on the frame upstanding member 11 by way of bearing housing flanges 43 and securing fasteners 44. The bearing housing 42 comprises a housing of ball bearings supporting a rotatable inner race that mates against the drive member. The drive member 41 freely spins within the housing 42 such that the drive member can be drive by a simple mechanism such as a hand crank 50, or a tool such as a pneumatic air gun or electric drill. The flanges of the housing 43 are fastened 44 through the upstanding member 11, while the connection between the drive member 41 and spool 30 passes through an aperture in the upstanding member 11.

Attached to the L-shaped frame member (11,12) is the trailer side rail connector 20, which comprises another L-shaped configuration comprising a vertical 13 and horizontal 14 member attached to the distal edge 16 of the shelf member 12. The L-shaped connector 20 secures within the rectangular pocket of a truck side rail pocket 61, wherein generally these pockets 61 are disposed along the truck side rail 60 for connection of cargo accessories or cargo strap connectors. When installed, the horizontal member 14 spans the pocket 61 width and the vertical member 13 is placed within the depth of the pocket. The horizontal member 14 prevents the L-shaped frame from rocking back while in position, whereafter the assembly can be disengaged from the pocket 61 by tilting the frame forward.

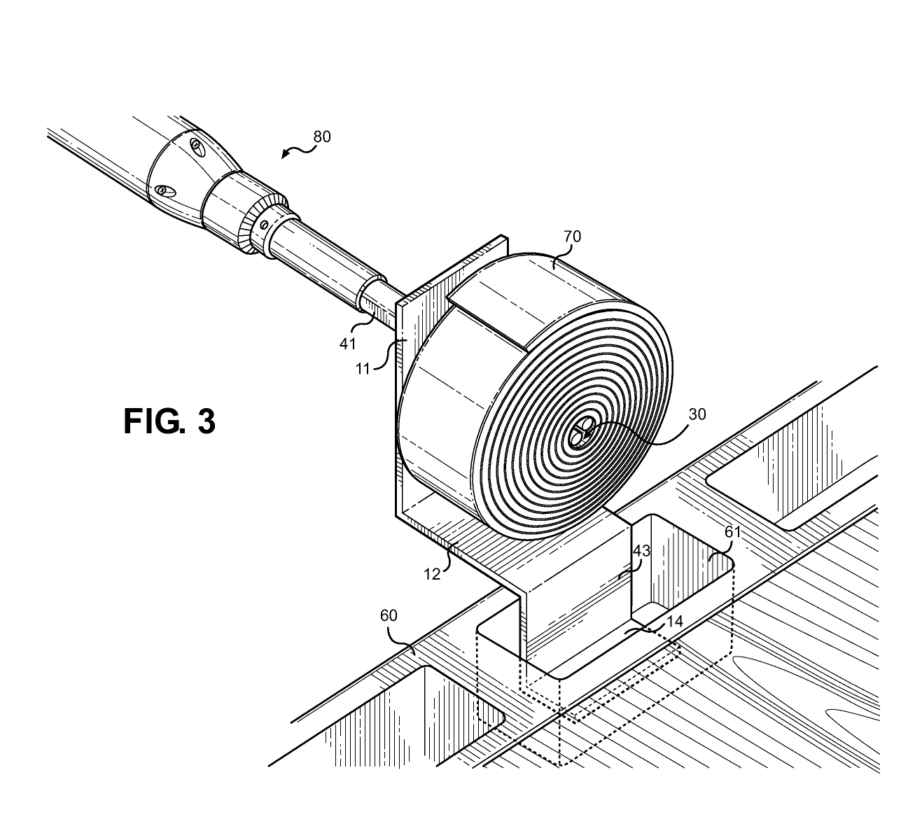

Referring finally to FIG. 3, there is shown an overhead perspective view of the present invention in a working state, being driven by an electric drill 80. As shown the lower connector is fit within the pocket 61 of a trailer side rail 60 and the shelf member 12 of the L-shaped frame extends over the edge of the side rail 60 during operation. The tongs of the spool 30 are placed in connection with a length of strap, whereafter the rear drive member 41 is driven by an electric motor (or equivalent tool) to winding the cargo strap 70 into a coiled state therearound and above the shelf member 12. The drive member 41 drives the spool 30 through the upstanding member 11 of the frame, wherein the spool is supported to freely rotate based on user input. As the spool 30 rotates and the cargo strap is wound in, the vertical 13 and horizontal members 14 of the pocket connector element maintain the position of the device and resist motion.

The present invention is convenient and readily deployable strap rolling and collecting apparatus for a trailer. The device comprises an attachable frame to the trailer side rail that provides a user with a tool to easily collect strap or tie-down straps after a truck or trailer has been unloaded, thereby reducing the amount of time it typically takes to stow these straps by hand. The device can be powered by hand crank or power tool, and prevents people's hands from becoming tired and sore from rolling the straps. Overall, the device provides a simple and ready to use tool that simplifies the stowage and collection of cargo straps for truckers and cargo haulers.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A strap collection device, comprising:
an L-shaped frame having an upstanding member and a shelf member;
a trailer side rail connector connected to said shelf member;
said trailer side rail connector comprising a vertical member and a horizontal member forming an L-shaped connector;
a spool rotatably connected to said frame along upstanding member and above said shelf member;
a drive member connected to said spool and extending from said upstanding member opposite of said spool.

2) The device of claim 1, wherein said spool comprises a first and second tong separated by a gap.

3) The device of claim 1, wherein said spool rotatable connection further comprises a bearing housing support.
